(19) United States
(12) Patent Application Publication
(10) Pub. No.: US 2007/0279783 A1
(43) Pub. Date: Dec. 6, 2007

(54) HELICAL-SCAN-TYPE MAGNETIC TAPE RECORDING AND REPRODUCING APPARATUS AND MAGNETIC TAPE RECORDING AND REPRODUCING METHOD

(75) Inventors: Toshiyuki HIROSE, Kanagawa (JP); Hideki Nonoyama, Kanagawa (JP); Osamu Nakamura, Kanagawa (JP); Akira Itou, Kanagawa (JP); Yoshinori Saito, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SONY CORPORATION, Tokyo (JP)

(21) Appl. No.: 11/752,537

(22) Filed: May 23, 2007

(30) Foreign Application Priority Data
Jun. 2, 2006 (JP) 2006-155017

(51) Int. Cl. G11B 27/36; G11B 5/09; G11B 15/14; G11B 21/02

(52) U.S. Cl. 360/31; 360/75; 360/64; 360/53

(57) ABSTRACT

A helical-scan-type magnetic tape recording and reproducing apparatus includes: a helical-scan-type recording head that is movable, while being attached to a distal end of an actuator, in a track width direction by displacement of the actuator itself to sequentially scan a magnetic tape; a helical-scan-type reproducing head that is movable, while being attached to a distal end of an actuator, in the track width direction by displacement of the actuator itself to sequentially scan a track on the magnetic tape recorded by the recording head; an error rate profile forming mechanism forming, by wobbling the reproducing head at each of plural points on the track, error rate profiles at the plural points; and a reproducing-head moving mechanism moving the reproducing head at the plural points, by finding a point with the best error rate from each error rate profile at the plural points from the error rate profile forming mechanism.

### CROSS REFERENCES TO RELATED APPLICATIONS

The present invention contains subject matter related to Japanese Patent Application JP 2006-155017 filed in the Japanese Patent Office on Jun. 2, 2006, the entire contents of which are incorporated herein by reference.

### BACKGROUND OF THE INVENTION

1. Field of the Invention

The present invention relates to a helical-scan-type magnetic tape recording and reproducing apparatus and magnetic tape recording and reproducing method which are suitably used for recording and reproducing computer data, for example.

2. Description of the Related Art

A helical-scan-type magnetic tape recording and reproducing apparatus is commonly used for the recording and storage of computer data. In such a helical-scan-type magnetic tape recording and reproducing apparatus used for data recording and storage, for example, as shown in FIG. 10, a recording head HW1, a reproducing head HR1, a recording head HW2, and a reproducing head HR2 are attached to a rotary drum 20 at intervals of 90 degrees.

In the helical-scan-type magnetic tape recording and reproducing apparatus, a magnetic tape (hereinafter, referred to as the tape) 10 is wound on the rotary drum 20 in a helical (spiral) fashion, and the rotary drum 20 is rotated at a constant speed and, at the same time, the tape 10 is run at a constant speed. As a result, the heads HW1, HW2, HR1, HR2 obliquely scan the tape 10 (see FIG. 11).

Upon recording information onto the tape 10 with two recording heads HW1 and HW2 of different azimuths, as shown in FIG. 12, band-like tracks Tr1, Tr2, Tr1, Tr2 . . . onto which information are recorded (written) are sequentially formed obliquely with respect to the tape 10. The track Tr1 is a track formed by the recording head HW1, and the track Tr2 is a track recorded by the recording head HW2.

Further, when two reproducing heads HR1 and HR2 of different azimuths are scanned across the tape 10 to reproduce information, the track Tr1 is reproduced by the reproducing head HR1, and the track Tr2 is reproduced by the reproducing head HR2. As described above, the helical-scan-type magnetic tape recording and reproducing apparatus having the two recording heads HW1 and HW2 and the two reproducing heads HR1 and HR2 as shown in FIG. 10 is generally configured so that information recorded by the recording head HW1 is reproduced by the reproducing head HR1, and information recorded by the recording head HW2 is reproduced by the reproducing head HR2, with the tracks Tr1 and Tr2 forming a pair.

Further, according to the head configuration shown in FIG. 10, in a normal, standard operation state in which the feed rate of the tape 10 and the rational speed of the rotary drum 20 are controlled at predetermined values, for example, the recording head HW1 and the reproducing head HR1 scan the area of the track Tr1 shown in FIG. 12 during 0.5 rotation in the first half of one rotation of the rotary drum 20, and the recording head HW2 and the reproducing head HR2 scan the area of the track Tr2 shown in FIG. 12 during 0.5 rotation in the second half. In the end, the two tracks Tr1, Tr2 are scanned with one rotation of the rotary drum 20.

In recent years, there is a very high need for achieving high-density recording for recording as much information as possible onto a magnetic tape, so the track width for recording magnetic information tends to become increasingly smaller. As an example of such a track width, the track width used in the currently used tape format called AIT4 is 4.4 μm.

The problem encountered when introducing a recording and reproducing system for a magnetic tape having such a narrow track width is the variation in height between the recording heads HW1 and HW2 with respect to the head-mounting surface of the rotary drum 20.

That is, when a tape is being fed at a predetermined speed, if the positions of the two recording heads HW1, HW2 attached to the rotary drum 20 of the head configuration shown in, for example, FIG. 10 are appropriate, then the widths of the magnetic patterns recorded onto the track Tr1, Tr2 should become uniform as shown in FIG. 12. However, if there is a difference in height between the recording heads HW1, HW2 and the positions of the recording heads HW1, HW2 are thus not appropriate, the widths of the magnetic patterns recorded onto the track are such that, for example, as shown in FIG. 13, a track Tr1 with a narrow width and a track Tr2 with a large width are alternately formed. Consequently, errors may frequently occur in the track Tr1 with a narrow width due to erroneous detection at the time of reproduction.

To address this problem, in the related art, it is common to provide a DT (Dynamic Tracking) reproducing head with a reproducing head attached to an actuator formed by a bimorph piezoelectric element or the like, and control the height of the reproducing head via the actuator so that a good reproduction signal is obtained upon reproducing information recorded on a track on a magnetic tape with this DT reproducing head (see Japanese Unexamined Patent Application Publication No. 2004-213847). However, with magnetic tape recording and reproducing apparatuses including such a DT reproducing head according to the related art, generally, only the reproducing head is driven and controlled by an actuator, and the recording head is separately fixed to the rotary drum without using an actuator.

That is, in the related art, when mounting and fixing the recording head HW to the rotary drum, the height of the recording head HW with respect to the mounting surface is adjusted. As shown in FIG. 17, this height adjustment is performed by first fixing the other end side of a head mounting bracket 27, which is provided to one end of the recording head HW, to a predetermined position of the rotary drum 20 in a substantially cantilevered fashion with a head-base fixing screw 28, and deforming the head mounting bracket 27 by a head-height adjusting screw 29.

As described above, according to the method of the related art, an actuator is provided to the recording head HR whereas no actuator is provided to the recording head HW. The reason for this is that during reproducing operation, provided that the bend of the track itself is the same, as the width of the track becomes narrower, it becomes more difficult to obtain a reproduction signal in a stable manner, and the bend of the track may not be ignored, and hence it is necessary to control the reproducing head so as to follow the bend of the track. Accordingly, at the time of reproduction, reproduction is performed while displacing the reproducing head HR by a dynamic tracking servo, thereby reducing reading errors at this time.

On the other hand, during a recording operation, previously recorded information is subjected to overwriting by the recording head and a new track is formed anew. Therefore, there is little need to drive the recording head HW1 by an actuator, and it is considered sufficient to simply adjust the recording head as to be fixed to a predetermined position of the rotary drum.

Further, with regard to the height adjustment of the recording head of a helical-scan-type magnetic tape recording and reproducing apparatus, the technique disclosed in Japanese Unexamined Patent Application Publication No. 8-63730 is known.

Japanese Unexamined Patent Application Publication No. 8-63730 discloses a rotary drum device that is applicable to a magnetic recording and reproducing apparatus such as a data recorder or a video tape recorder.

The rotary drum device described in Japanese Unexamined Patent Application Publication No. 8-63730 includes magnetic head height detecting means (displacement sensor) for measuring the heights of magnetic heads, which are used for both recording and reproduction, and outputting the height measurement results, magnetic head height variable means (piezoelectric element, actuator) for making the heights of the magnetic heads variable in accordance with a drive signal within a range of about one track pitch with respect to the rotation axis direction of the rotary drum, and drive means for outputting a drive signal on the basis of the results of height measurement by the height detecting means. Further, relative position data representing data on the relative position between the magnetic heads obtained by using a predetermined reference tape in the final adjustment process, in particular, is stored into a memory circuit, the relative heights of the magnetic heads are monitored, and the relative heights are retained at prescribed values on the basis of the relative position data stored in the memory circuit, thereby performing height adjustment of the magnetic heads provided to the rotary drum.

### SUMMARY OF THE INVENTION

However, in the magnetic tape recording and reproducing apparatus according to the related art in which an actuator is provided only to the reproducing head, although the position of the reproducing head with respect to the track width direction can be controlled in a satisfactory manner at the time of reproducing from the magnetic tape, at the time of recording onto the magnetic tape, the width of the track to be formed is determined by the mounting height, that is, the mechanical dimensional accuracy of the recording head. This is due to the fact that the recording head is fixed to the rotary drum.

In particular, as the width of the track to be recorded is made narrower in response to the demand for achieving high-density recording onto a magnetic tape, greater dimensional accuracy is required with respect to the track width between adjacent tracks. Therefore, in the case of recording heads mechanically fixed to the rotary drum, adjusting the mounting heights of the plurality of recording heads becomes a delicate operation, and it is difficult to maintain a predetermined accuracy for a long period of time.

Further, even when adopting the method as shown in FIG. 17 in which the height adjustment of the recording head HW1 is effected by deforming the head mounting bracket 27 by the head-height adjusting screw 29, it is difficult to control and adjust the height (height position with respect to the track width direction) within an accuracy of, for example, about +0.1 μm. Even if the head height can be adjusted in a production line, the residual stress accumulated during the adjusting operation with the head-height adjusting screw 29 causes the head mounting bracket 27 itself to deform due to environmental factors such as temperature or changes with time, which may lead to increased defective parts in the assembly of the rotary drum 20 or reduced reliability of the magnetic tape recording and reproducing apparatus.

Further, in the technique disclosed in Japanese Unexamined Patent Application Publication No. 2004-213847, since the height of the DT head is alternately changed (wobbled) by a fixed amplitude in the positive direction and by a fixed amplitude in the negative direction for each one scan (one track), when the height of the DT head is alternately changed (wobbled) by a fixed amplitude in the positive direction and by a fixed amplitude in the negative direction while reading out data, there is a fear that the entire data corresponding to one scan (one track) may not be obtained.

In the system described in Japanese Unexamined Patent Application Publication No. 8-63730 in which the relative position of the magnetic head is monitored by a displacement sensor while performing reproduction using a dedicated reference tape, and the head is driven by an actuator (piezoelectric element) to the final adjustment value, since a displacement sensor provided to the rotary drum is required in order to detect the height of the head, an increase in apparatus cost is inevitable. Although this system proves advantageous in maintaining the apparatus performance due to the use of the reference tape for adjustment, making the adjustment by the user himself/herself is a heavy burden to the user.

It is desirable to perform recording and reproduction in a satisfactory manner with respect to a magnetic tape having a narrow track width.

A helical-scan-type magnetic tape recording and reproducing apparatus according to an embodiment of the present invention includes: helical-scan-type first and second recording heads configured to be movable, while being attached to distal ends of respective actuators, in a track width direction due to displacement of the respective actuators themselves so as to sequentially scan a magnetic tape; helical-scan-type first and second reproducing heads configured to be movable, while being attached to distal ends of respective actuators, in the track width direction due to displacement of the respective actuators themselves so as to sequentially scan first and second tracks on the magnetic tape recorded by the first and second recording heads; error rate profile forming means for forming, by wobbling the first and second reproducing heads at each of a plurality of points on the tracks, error rate profiles at the plurality of points; reproducing-head moving means for moving the reproducing heads at the plurality of points, by finding a point with the best error rate from each of the error rate profiles at the plurality of points from the error rate profile forming means; track width calculating means for calculating widths of the tracks recorded by the first and second recording heads from the error rate profiles; and track-width uniformizing means for supplying a control voltage to each of the actuators of the first and second recording heads so that track widths recorded by the first and second recording heads become uniform at the plurality of points.

A helical-scan-type magnetic tape recording and reproducing method according to an embodiment of the present invention includes the steps of: forming first and second tracks by performing recording onto a magnetic tape by helical-scan-type first and second recording heads, the first and second recording heads being configured to be movable, while being attached to distal ends of respective actuators, in a track width direction due to displacement of the respective actuators themselves; sequentially scanning by helical-scan-type first and second reproducing heads the first and second tracks on the magnetic tape recorded by the first and second recording heads, the first and second reproducing apparatus being configured to be movable, while being attached to distal ends of respective actuators, in the track width direction due to displacement of the respective actuators themselves; forming, by wobbling the first and second reproducing heads at each of a plurality of points on the first and second tracks, error rate profiles at the plurality of points; reproducing-head moving means for moving the reproducing heads at the plurality of points, by finding a point with the best error rate from each of the error rate profiles at the plurality of points; calculating widths of the tracks recorded by the first and second recording heads from the error rate profiles; and updating a control voltage to be supplied to each of the actuators of the first and second recording heads for each of the plurality of points so that track widths recorded by the first and second recording heads become uniform at the plurality of points.

According to the present invention, the reproducing head scans the portion with the best rate at each of the plurality of points on the track, thereby making it possible to reproduce data in a satisfactory manner even in the case of a narrow track.

According to the present invention, wobbling is performed at a plurality of points on the track in determining an update of the control voltage for the actuator of the reproducing head. Accordingly, although an error may occur at each of these points, there is no fear of an error occurring for the track as a whole, thus allowing data reproduction to be performed in a satisfactory manner.

Further, according to the present invention, on the basis of the error rate profiles at the plurality of points on the track, a control voltage is supplied to the actuator of the recording head so that the recording track width by the recording head becomes uniform at these points. Therefore, the height of the recording head is controlled in a satisfactory manner, and the recording track width can be made uniform at all times.

### BRIEF DESCRIPTION OF THE DRAWINGS

FIG. 1 is a schematic diagram showing a helical-scan-type magnetic recording and reproducing apparatus according to an embodiment of the present invention;

FIGS. 2A to 2C are views showing the configuration of a reproducing head and a recording head that are movable in the track width direction;

FIG. 3 is a diagram showing an example of the configuration of a track of a magnetic tape used in a helical-scan-type magnetic recording and reproducing apparatus according to an embodiment of the present invention;

FIG. 4 is a diagram showing an example of the track format on a magnetic tape;

FIG. 5 is a diagram showing a table illustrating the correspondence between points and header addresses;

FIG. 6 is a flow chart for explaining the present invention;

FIG. 7 is a flow chart for explaining the present invention;

FIG. 8 is a diagram showing an example of an error rate profile;

FIGS. 9A to 9C are diagrams for explaining the present invention;

FIG. 10 is a schematic diagram showing an example of the relationship between reproducing heads and recording heads of a helical-scan-type magnetic recording and reproducing apparatus according to the related art;

FIG. 11 is a schematic diagram showing an example of a tracking servo system;

FIG. 12 is an explanatory diagram;

FIG. 13 is an explanatory diagram;

FIG. 14 is an explanatory diagram;

FIG. 15 is an explanatory diagram;

FIG. 16 is a diagram showing an example of the output characteristic of an actuator; and

FIG. 17 is a schematic diagram showing an example of positional adjustment of a recording head of a helical-scan-type magnetic recording and reproducing apparatus according to the related art.

### DESCRIPTION OF THE PREFERRED EMBODIMENTS

Description will now be given of a helical-scan-type magnetic tape recording and reproducing apparatus and magnetic tape recording and reproducing method according to an embodiment of the present invention.

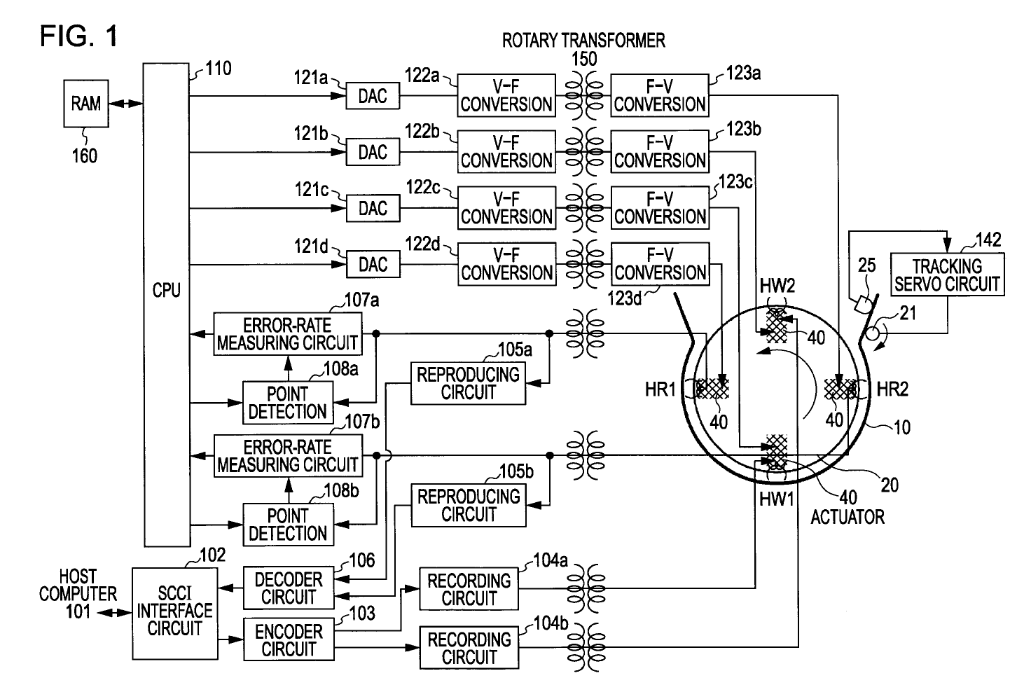

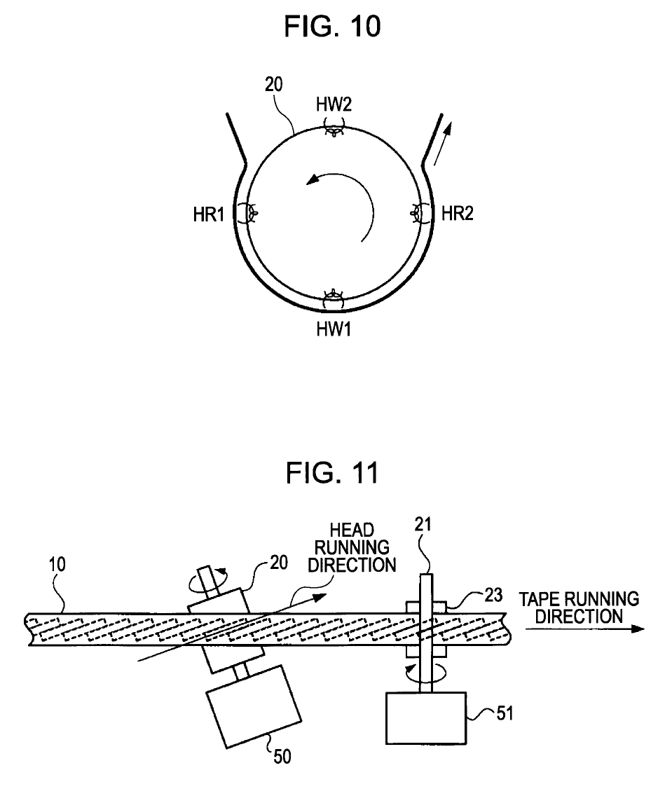

FIG. 1 shows the configuration of the main portion of the helical-scan-type magnetic tape recording and reproducing apparatus according to this embodiment. As shown in FIG. 10, for example, in the helical-scan-type magnetic tape recording and reproducing apparatus, a recording head HW1, a reproducing head HR1, a recording head HW2, and a reproducing head HR2 are attached to a rotary drum 20 at intervals of 90 degrees. Different azimuth angles are denoted by subscripts 1, 2. A track Tr1 recorded by the recording head HW1 is reproduced by the reproducing head HR1, and a track Tr2 recorded by the recording head HW2 is reproduced by the reproducing head HR2.

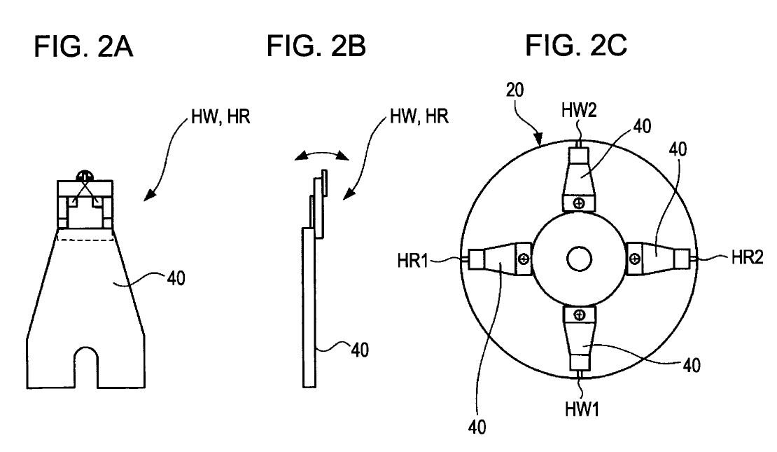

As shown in FIGS. 2A to 2C, the two recording heads HW1 and HW2 and the two reproducing heads HR1 and HR2 are each attached to the distal end of an actuator 40. The actuator 40 itself is displaced in accordance with the polarity and magnitude of a control voltage applied to each of electrodes provided on the front and back of the actuator 40. Further, as shown in FIG. 2B, each of the recording heads HW1 and HW2 and reproducing heads HR1 and HR2 itself is movable in both directions indicated by the arrows due to the displacement of the actuator 40.

That is, as shown in FIG. 2C, each of the recording heads HW1 and HW2 and reproducing heads HR1 and HR2 itself is made displaceable in the width direction of the track by being attached to the rotary drum 20 via the other end of the actuator 40. A piezoelectric element or the like is used as the actuator 40. As shown in, for example, FIG. 16, this piezoelectric element can be imparted with a displacement characteristic of about 1 μm/10 V.

In the example shown in FIG. 1, recording data sent from a host computer 101 is received by a helical-scan-type magnetic tape recording and reproducing apparatus via an SCSI interface circuit 102, for example. Then, this data is converted into a recording analog signal by an encoder circuit 103 and subjected to predetermined waveform shaping by a recording circuit 104a and a recording circuit 104b before being recorded via a rotary transformer (RT) 150 onto a tape 10 by the recording heads HW1 and HW2 provided to the rotary drum 20.

On the other hand, reproducing signals from the reproducing heads HR1 and HR2 provided to the rotary drum 20 are respectively subjected to amplification/equalization/detection or the like by a reproducing circuit 105a and a reproducing circuit 105b, decoded by a decoder circuit 106 into reproducing data in the form of digitized signals, and sent to the host computer 101 from the SCSI interface circuit 102.

Further, the reproducing signals obtained with the reproducing heads HR1 and HR2 are also used for the drive/control of the actuator 40, and error rates at which these reproducing signals are erroneously reproduced (read) are respectively measured by an error-rate measuring circuit 107a and an error-rate measuring circuit 107b. The measured error rates are subjected to AV conversion before being transmitted to a CPU 110.

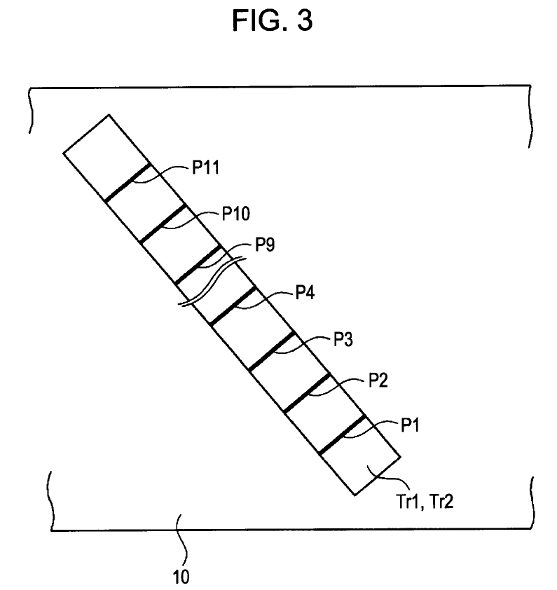

The error-rate measuring circuits 107a and 107b measure error rates at a plurality of points on the tracks Tr1, Tr2 that will be described later, for example, 11 points P1, P2 . . . P11 set at, for example, equal intervals at the same positions of the tracks Tr1, Tr2 as shown in FIG. 3.

Further, these reproducing signals are supplied to point detecting circuits 108a and 108b. Upon arrival at the point P1, P2, . . . P11 set by the CPU 110 in advance, the point detecting circuits 108a and 108b inform the error-rate measuring circuits 107a and 107b of the arrival at a measurement point, thus performing measurement of the error rate at that point.

Further, the CPU 110 includes a RAM (memory) 160 serving as a storage area for the error rates at the respective points P1, P2, . . . P11 and the like.

As for the signal for driving/controlling the actuator 40 to which each of the recording heads HW1 and HW2 and reproducing heads HR1 and HR2 is attached, first, as shown in FIG. 1, a digital control voltage from the CPU 110 is outputted to DAC circuits 121a, 121b, 121c, and 121d as a control voltage for applying a desired drive voltage to the actuator 40. Then, this control voltage is converted into an analog signal through DA conversion by each of the DAC circuits 121a, 121b, 121c, and 121d, and the control voltage in the form of an analog signal is converted into a predetermined frequency signal by each of V-F conversion circuits 122a, 122b, 122c, and 122d. The predetermined frequency signal is converted into a voltage via the rotary transformer 150 by each of F-V conversion circuits 123a, 123b, 123c, and 123d provided therein, and restored to a control voltage for driving/controlling the actuator 40.

Since the rotary transformer 150 cannot transmit a DC voltage, the rotary transformer 150 uses the V-F conversion circuits 121a, 122b, 122c, and 122d and the F-V conversion circuits 123a, 123b, 123c, and 123d in combination. Further, the actuator 40 used has such a characteristic that, like a piezoelectric element, for example, its displacement changes in accordance with the voltage. In this embodiment, as shown in FIG. 16, one with a displacement characteristic of about 1 μm/10 V is used.

Further, as shown in FIG. 1, the helical-scan-type magnetic tape recording and reproducing apparatus according to this embodiment records a CTL (control track) onto the tape 10, simultaneously with the recording of information onto the track by the recording heads HW1 and HW2. At the time of reproduction, the CTR track on the tape 10 is detected by a CTR head 25, and on the basis of the CTR track signal thus obtained and a head switching pulse (PG pulse) generated in accordance with the rotation of the rotary drum 20, the feed rate of the tape 10 is adjusted by using a capstan 21 (FIG. 11) provided to a rotary shaft. This feed rate adjustment is effected by controlling the phase of a capstan motor 51 on the basis of a control signal outputted from a tracking servo circuit 142.

Next, referring to FIG. 10, description will be given of the feeding of the tape 10 in the helical-scan-type magnetic tape recording and reproducing apparatus according to this embodiment, and the scanning operations of the recording heads HW1 and HW2 and reproducing heads HR1 and HR2 on the tape 10.

FIG. 10 shows the rotary drum 20 of the helical-scan-type magnetic tape recording and reproducing apparatus according to this embodiment. The recording heads HW1 and HW2 and the reproducing heads HR1 and HR2 are attached to the rotary drum 20, and the tape 10 is wound on the rotary drum 20 in a helical (spiral) form.

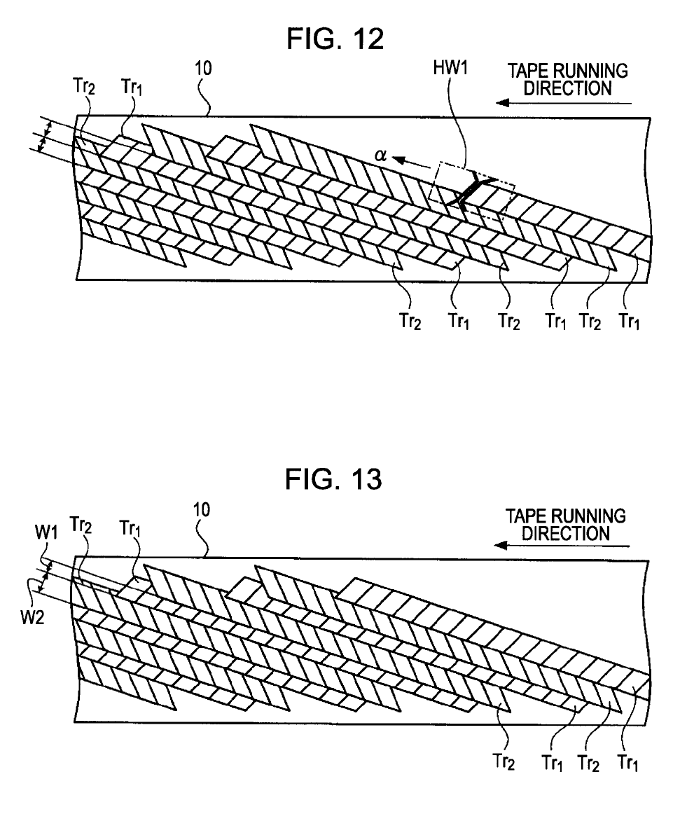

As shown in FIG. 12, as the rotary drum 20 is rotationally driven by a drum motor 50, the recording heads HW1 and HW2 and the reproducing heads HR1 and HR2 obliquely scan the tape 10 being fed at a constant rate. Information (tracks Tr1, Tr2, Tr1, Tr2, . . . ) such as those shown in FIG. 12 are thus written (recorded) onto the tape 10 by the recording heads HR1 and HR2, and the recorded information are read (reproduced) by the reproducing heads HR1 and HR2.

At this time, information recorded by the recording head HW1 is reproduced by the reproducing head HR1, and information recorded by the recording head HW2 is reproduced by the reproducing head HR2.

In this case, the reproducing head HR1 an the recording head HW1, and the reproducing head HR2 and the recording head HW2 are attached to the rotary drum 20 at substantially the same height so that they follow the same orbit when the rotary drum 20 rotates about its axis at a constant RPM, and in such a way that their respective rotation axes become symmetrical (see FIG. 10).

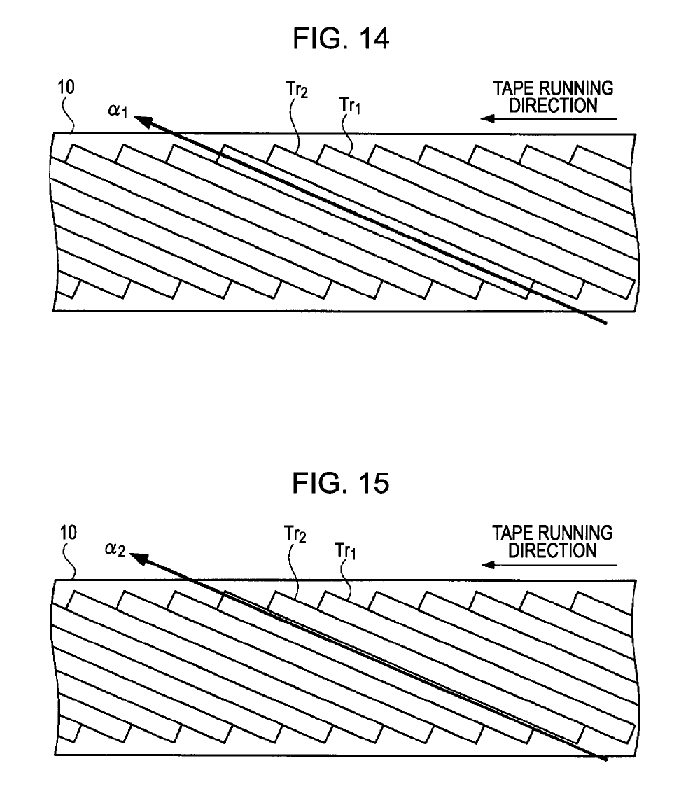

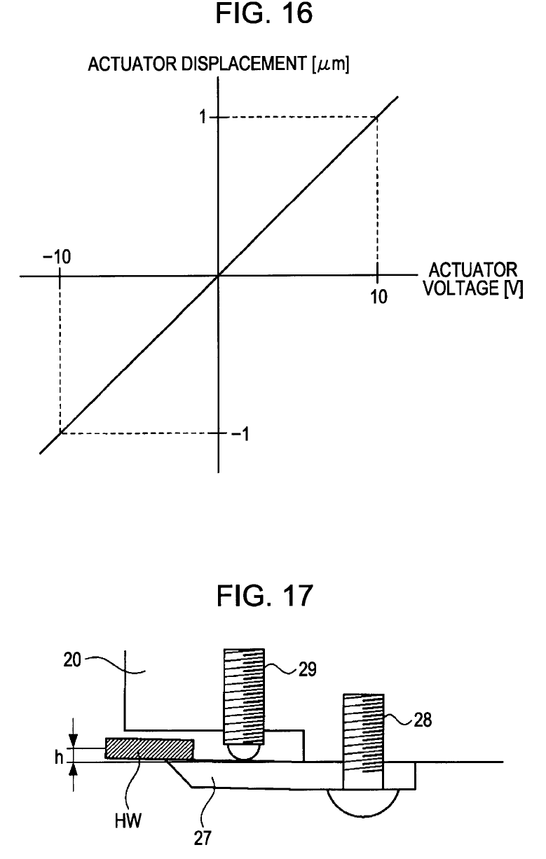

As shown in FIG. 11, the tape 10 is fed as the capstan 21 is rotated by the capstan motor 51 with the tape 10 being held between a pinch roller 23 and the capstan 21. At this time, during tape feeding operation in the reproduction mode, as shown in FIG. 14, the tape feed rate is adjusted by a tracking servo so that the running locus α1 of the reproducing head HR1 (or HR2) traces a substantially centerline of the track Tr (so that it is on-track).

According to the head configuration shown in FIG. 10, in a normal, standard operation state in which the feed rate of the tape 10 and the rational speed of the rotary drum 20 are controlled at predetermined values, for example, the recording head HW1 and the reproducing head HR1 scan the area of the track Tr1 shown in FIG. 12 during 0.5 rotation in the first half of one rotation of the rotary drum 20, and the recording head HW2 and the reproducing head HR2 scan the area of the track Tr2 shown in FIG. 12 during 0.5 rotation in the second half. In the end, the two tracks Tr1 and Tr2 are scanned with one rotation of the rotary drum 20.

Accordingly, the tracks Tr1 and Tr2 are formed in the areas scanned by the recording heads HW1 and HW2 and information are recorded onto the tracks Tr1 and Tr2. The recorded information are reproduced as the reproducing heads HR1 and HR2 scan the tracks Tr1 and TR2 on which information have been thus recorded. At this time, new information is recorded, and data reproduction (read-after-write (simultaneous recording and reproduction) for verifying that information has been recorded without error is performed at slightly shifted timing.

In a helical scan system in which the tape 10 is wound on the rotary drum 20 in a spiral fashion and the rotary head scans the tape 10, the running conditions of the reproducing heads HR1 and HR2 are roughly classified into a case (locus α1) in which the reproducing heads HR1 and HR2 are running on-track as described above so as to trace the substantially centerline of the track Tr as shown in FIG. 14, and a case (locus α2) in which the reproducing heads HR1 and HR2 are running off-track so as to deviate from the centerline as shown in FIG. 15.

Next, the track Tr1, Tr2 of the magnetic tape 10 used in the helical-scan-type magnetic tape recording and reproducing apparatus according to this embodiment will be described with reference to FIGS. 3, 4, and 5. As shown in FIG. 3, at the time of data recording, a plurality of, for example, 11 measurement points P1, P2, . . . P11 are recorded in a dispersed fashion at substantially equal intervals on the track Tr1, Tr2.

Generally, the smaller the width of the track Tr1, Tr2, the more the track Tr1, Tr2 is curved in an S shape, and it is necessary for data reproduction to be performed in a satisfactory manner from the track Tr1, Tr2 of such a curved shape by the reproducing head HR1, HR2. To this end, in order to ensure that data reproduction be performed along the curved shape of the track Tr1, Tr2, according to this embodiment, a plurality of, for example, 11 points P1, P2, . . . P11 are determined on the track Tr1, Tr2, and error rates at these 11 points P1, P2, . . . P11 are sequentially measured. The number of these measurement points may be determined as required.

These measurement points P1, P2, . . . P11 will now be described. As these points P1, P2, . . . P11, header addresses for identifying individual data blocks from among a large number of data blocks constituting a track format are used. The use of the header addresses means that it is not necessary to record redundant signals for DT (Dynamic Tracking) servo.

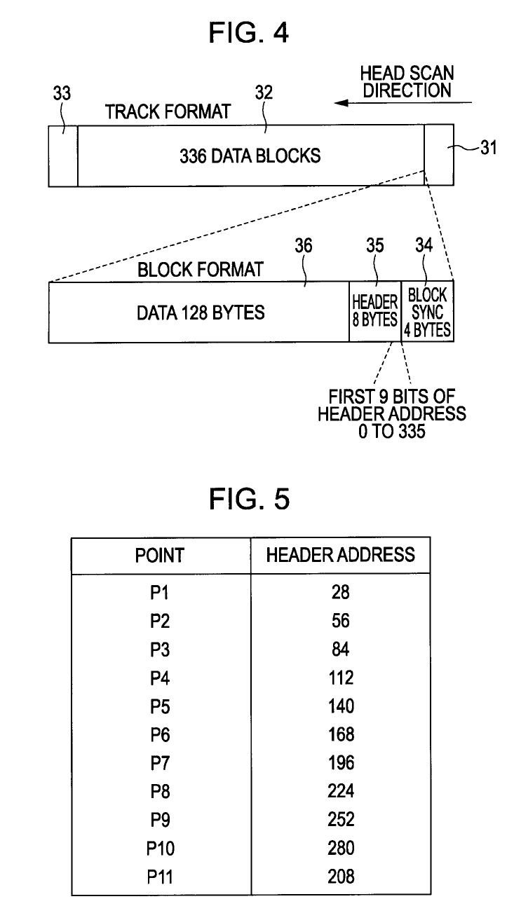

An example of track format (AIT3 format) is shown in FIG. 4. In this case, the space between a preamble 31 and a post amble 32 serves as a data area 32. 336 data blocks are successively recorded within the data area 32. As represented as a block format, each individual data block includes a block sync (block synchronization) of 4 bytes, a header 35 of 8 bytes, and data 36 of 128 bytes.

The above-described header addresses are addresses (0 to 511) represented by the first 9 bits of the header 35. In this case, since the number of data blocks on one track Tr1 (Tr2) is set as 336, for example, 11 header addresses are selected as appropriate as the measurement points P1, P2, . . . P11 from among 0 to 355. In order for the bend of the track Tr1, Tr2 to be uniformly measured along the entire length of the track Tr1, Tr2, for example, as shown in FIG. 5 in the form of a table representing the correspondence between the points P1, P2, . . . P11 and header addresses, the points may se selected at substantially equal intervals and, as shown in this correspondence table, under a state in which correspondence is established between the measurement points P1, P2, . . . P11 and the header addresses.

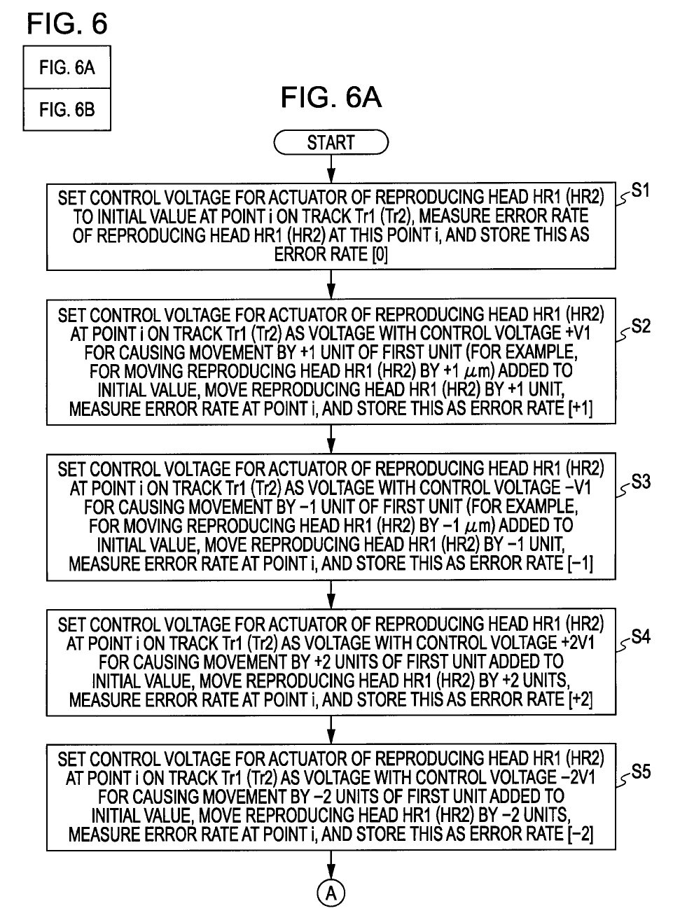

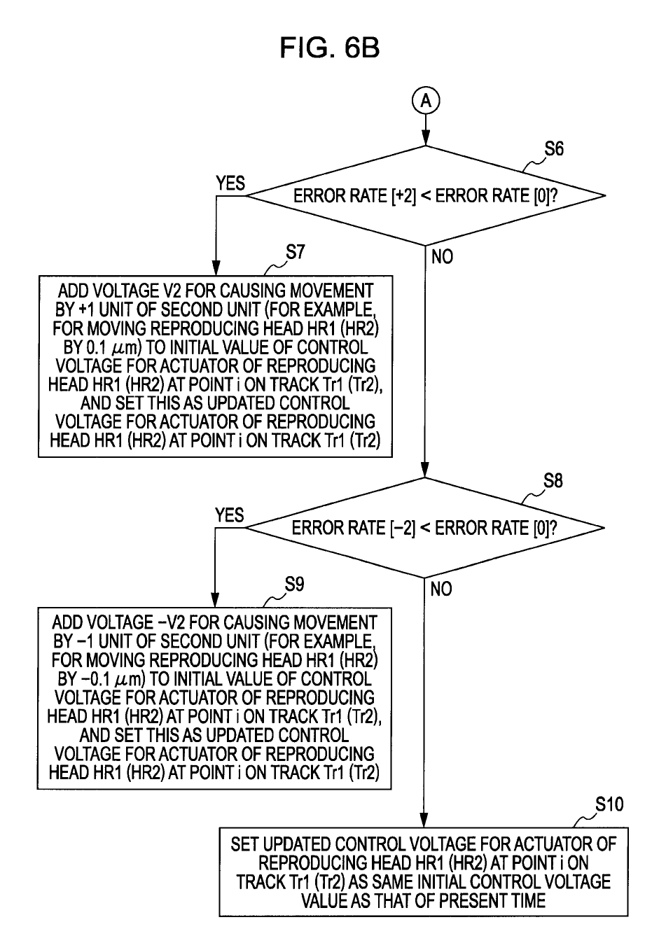

In this embodiment, during data recording (read-after-write), the operations of the flow chart shown in FIG. 6 are sequentially executed with respect to each measurement point P1, P2, . . . P11 of each of the tracks Tr1, Tr2, and a control voltage to be supplied to the actuator 40 of the reproducing head HR1, HR2 at each of the points P1, P2, . . . P11 is determined and stored.

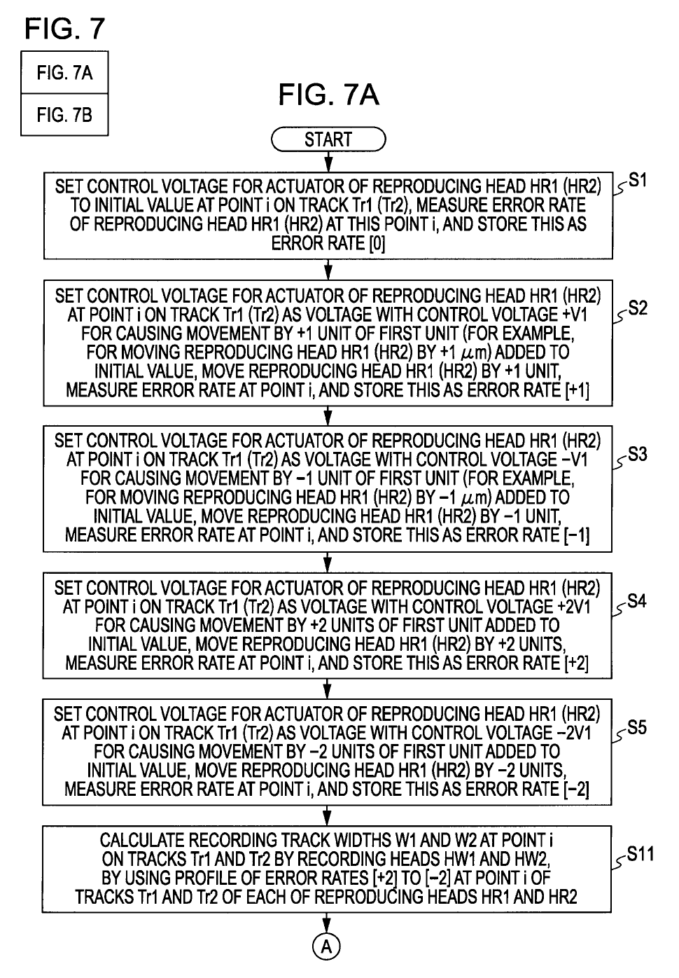

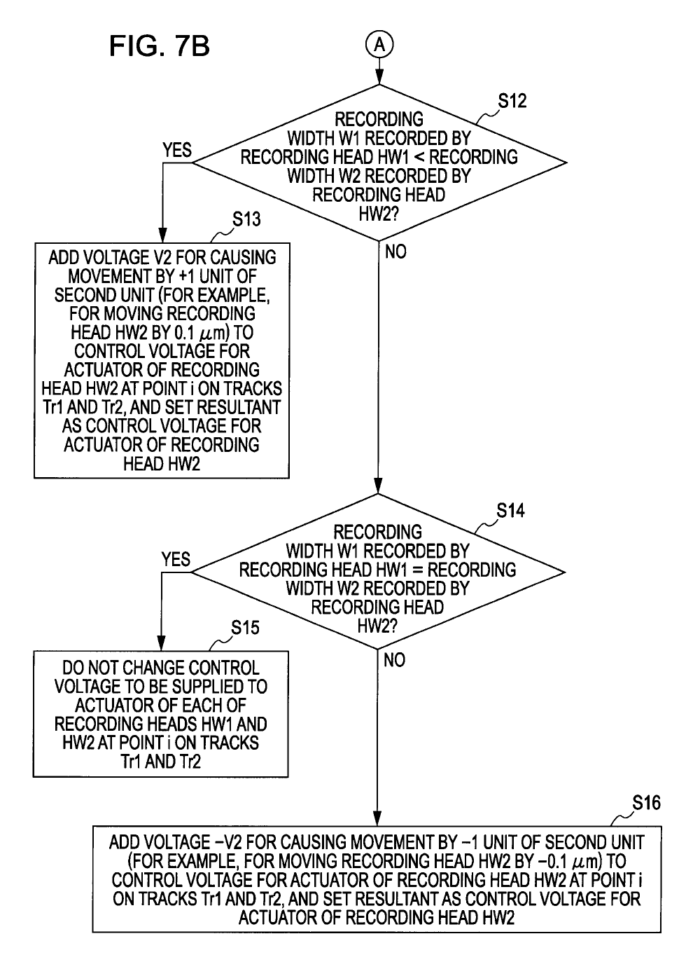

Further, in this embodiment, during data recording (read-after-write), the operations of the flow chart shown in FIG. 7 are sequentially executed with respect to each measurement point P1, P2, . . . P11 of each of the tracks Tr1, Tr2, and a control voltage to be supplied to the actuator 40 of the recording head HW1, HW2 at each of the points P1, P2, . . . P11 is determined and stored.

In this embodiment, during data recording (read-after-write), the above-mentioned processing is repeated, and for each of the points P1, P2, . . . P11, the recorded control voltage is updated and supplied to each actuator 40.

Referring to the flow chart shown in FIG. 6, the reproducing heads HR1 and HR2 similarly execute the operations of the flow chart shown in FIG. 6. When the operation of data recording (read-after-write) is started, at the time of first scan, a reproduction signal from the reproducing head HR1 (HR2) is supplied to each of the error-rate measuring circuit 107a (107b) and point detecting circuit 108a (108b). Upon detecting the point P1 on the track Tr1 (Tr2) by the point detecting circuit 108a (108b), the error rate at the point P1 is measured by the error-rate measuring circuit 107a (107b), and the error rate at this time is stored as the error rate [0] at the point P1 into the memory 160 via the CPU 110 (step S1). In this case, an initial value is supplied to the actuator 40 of the reproducing head HR1 (HR2) as a control voltage.

At the next scan of the reproducing head HR1 (HR2), a reproduction signal from the reproducing head HR1 (HR2) is supplied to each of the error-rate measuring circuit 107a (107b) and point detecting circuit 108a (108b). Upon detecting the point P1 on the track Tr1 (Tr2) by the point detecting circuit 108a (108b), a voltage with this initial value added to a voltage V1 for causing movement by +1 unit of a first unit (for example, for moving the reproducing head HR1 (HR2) by +1 μm), for example, 10 V, is supplied to the actuator 40 of the reproducing head HR1 (HR2) as a control voltage, thus moving (wobbling) the reproducing head HR1 (HR2) by +1 unit. The error rate at the point P1 is measured by the error-rate measuring circuit 107a (107b) at this time, and the error rate at this time is stored as the error rate [+1] at the point P1 into the memory 160 via the CPU 110 (step S2).

At the next scan of the reproducing head HR1 (HR2), a reproduction signal from the reproducing head HR1 (HR2) is supplied to each of the error-rate measuring circuit 107a (107b) and point detecting circuit 108a (108b). Upon detecting the point P1 of the track Tr1 (Tr2) by the point detecting circuit 108a (108b), a voltage with this initial value added to a voltage −V1 for causing movement by −1 unit (for example, for moving the reproducing head HR1 (HR2) by −1 μm), for example, −10 V, is supplied to the actuator 40 of the reproducing head HR1 (HR2) as a control voltage, thus moving (wobbling) the reproducing head HR1 (HR2) by −1 unit. The error rate at the point P1 is measured by the error-rate measuring circuit 107a (107b) at this time, and the error rate at this time is stored as the error rate [−1] at the point P1 into the memory 160 via the CPU 110 (step S3).

At the next scan of the reproducing head HR1 (HR2), a reproduction signal from the reproducing head HR1 (HR2) is supplied to each of the error-rate measuring circuit 107a (107b) and point detecting circuit 108a (108b). Upon detecting the point P1 of the track Tr1 (Tr2) by the point detecting circuit 108a (108b), a voltage with this initial value added to a voltage 2V1 for causing movement by +2 units of the first unit, for example, 20 V, is supplied to the actuator 40 of the reproducing head HR1 (HR2) as a control voltage, thus moving (wobbling) the reproducing head HR1 (HR2) by +2 units. The error rate at the point P1 is measured by the error-rate measuring circuit 107a (107b) at this time, and the error rate at this time is stored as the error rate [+2] at the point P1 into the memory 160 via the CPU 110 (step S4).

At the next scan of the reproducing head HR1 (HR2), a reproduction signal from the reproducing head HR1 (HR2) is supplied to each of the error-rate measuring circuit 107a (107b) and point detecting circuit 108a (108b). Upon detecting the point P1 of the track Tr1 (Tr2) by the point detecting circuit 108a (108b), a voltage with this initial value added to a voltage −2V1 for causing movement by −2 units of the first unit, for example, −20 V, is supplied to the actuator 40 of the reproducing head HR1 (HR2) as a control voltage, thus moving (wobbling) the reproducing head HR1 (HR2) by −2 units. The error rate at the point P1 is measured by the error-rate measuring circuit 107a (107b) at this time, and the error rate at this time is stored as the error rate [−2] at the point P1 into the memory 160 via the CPU 110 (step S5).

Next, the CPU 110 determines whether or not the following relationship holds with respect to the point P1 of the track Tr1 (Tr2) (step S6):

error rate[+2]<error rate[0]

If the error rate [0] is larger than the error rate [+2], a voltage V2 for causing movement by +1 unit of a second unit (for example, for moving the reproducing head HR1 (HR2) by 0.1 μm), for example, 1 V, is added to the initial value of the control voltage for the actuator 40 of the reproducing head HR1 (HR2) at the point P1 on the track Tr1 (Tr2), and the resultant is set as an updated control voltage for the actuator 40 of the reproducing head HR1 (HR2) at the point P1 on the track Tr1 (Tr2) (step S7).

If it is determined in step S6 that the error rate [0] is not larger than the error rate [+2], the process transfers to step S8, and it is determined whether or not the following relationship holds:

error rate[−2]<error rate[0]

If the error rate [0] is larger than the error rate [−2], a voltage −V2 for causing movement by −1 unit of the second unit (for example, for moving the reproducing head HR1 (HR2) by −0.1 μm), for example, −1 V, is added to the initial value of the control voltage for the actuator 40 of the reproducing head HR1 (HR2) at the point P1 of the track Tr1 (Tr2), and the resultant is set as an updated control voltage for the actuator 40 of the reproducing head HR1 (HR2) at the point P1 of the track Tr1 (Tr2) (step S9).

If the result of the determination in step S8 is [NO], it is determined that

error rate[+2]=error rate[0]=error rate[−2],

and the updated control voltage for the actuator 40 of the reproducing head HR1 (HR2) at the point P1 of the track Tr1 (Tr2) is set as the same initial control voltage value as that of the present time (step S10).

In this embodiment, the operations of the flow chart shown in FIG. 6 are sequentially executed in the manner as described above also with respect to the point P2, P3, . . . P11 of the track Tr1 (Tr2), and an updated control voltage for the actuator 40 of the reproducing head HR1 (HR2) at the point P1, P2, . . . P11 of the track Tr1 (Tr2) is determined.

Since the above-described processing is repeated in this embodiment, the reproducing head HR1, HR2 scans the portion of the track Tr1, TR2 with the best error rate, thus making it possible to perform data reproduction in a satisfactory manner even in the case of a narrow track.

In this embodiment, since the reproducing head HR1 (HR2) is subjected to wobbling at the point P1, P2, . . . P11 of the track Tr1 (TR2), an error may occur at the point P1, P2, . . . P11. However, there is no fear of an error occurring for the track as a whole.

In this embodiment, after the operations of the flow chart shown in FIG. 6 are executed with respect to the point P1, P2, . . . . P11 of the track Tr1 (TR2), the operations of the flow chart shown in FIG. 7 for achieving a uniform track width are executed.

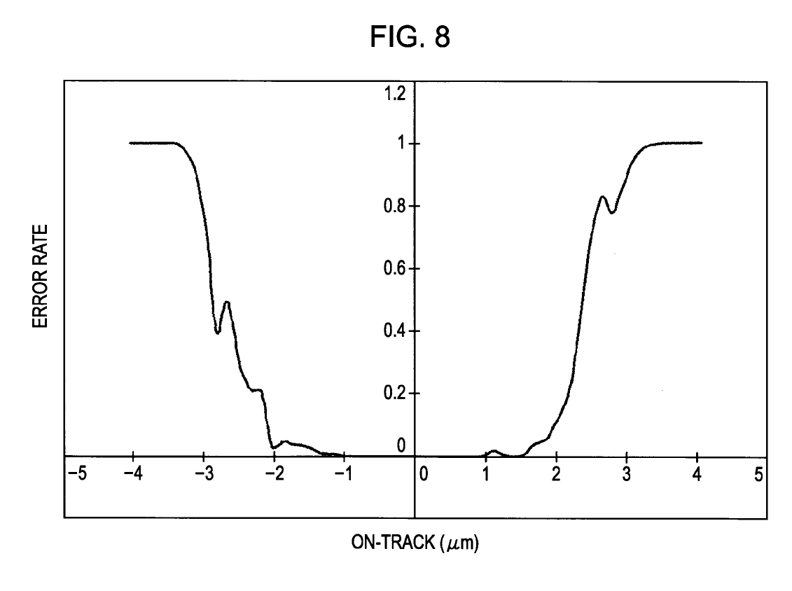

Referring to the flow chart of FIG. 7, in the flow chart of FIG. 7, steps S1 to S5 are the same as steps S1 to S5 of FIG. 6, so description thereof is omitted. In step S11 of the flow chart of FIG. 7 according to this embodiment, the error rates [+2] to [−2] at the point P1 of the tracks Tr1 and Tr2 of each of the reproducing heads HR1 and HR2 are used to obtain an error rate profile (see FIG. 8) at the point P1 of the tracks Tr1 and Tr2. Then, as shown in FIG. 8, by using the error rate profile at the point P1 of the tracks Tr1 and Tr2, the recording track widths W1 and W2 at the point P1 of the tracks Tr1 and Tr2 due to the recording heads HW1 and HW2 are calculated.

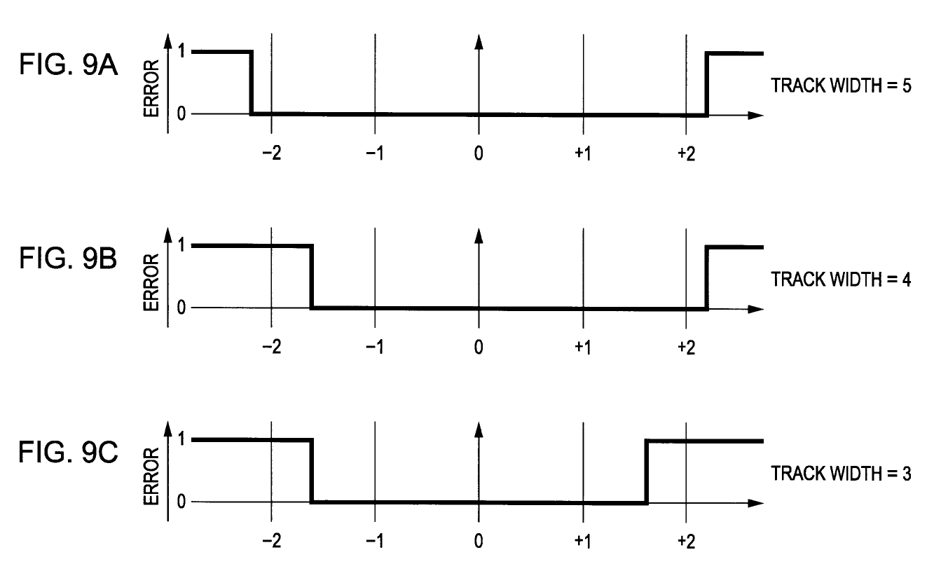

For example, as shown in FIGS. 9A, 9B, and 9C, when the error rate in the error rate profile as shown in FIG. 8 is not higher than 0.1, this is set as error [0], and when the error rate is higher than 0.1, this is set as error [1], and the track widths W1 and W2 are digitized into numerical data with the width of the error [0] taken as the width of each of the tracks Tr1 and Tr2.

Next, the process transfers to step S12, and it is determined whether or not the recording track width W2 recorded by the recording head HW2 is larger than the recording track width W1 recorded by the recording head HW1. If it is determined that the recording track width W2 is larger than the recording track width W1, the voltage V2 for causing movement by +1 unit of the second unit (for example, for moving the recording head HW2 by 0.1 μm), for example, 1V, is added to the control voltage for the actuator 40 of the recording head HW2 at the point P1 of the tracks Tr1 and Tr2, and the resultant is set as the control voltage for the actuator 40 of the recording head HW2 (step S13).

If it is determined in step S12 that the recording track width W2 is not larger than the recording track width W1, it is determined whether or not the recording track width W2 recorded by the recording head HW2 and the recording track width W1 recorded by the recording head HW1 are equal (step S14). If it is determined that the recording track widths W1 and W2 are equal, the control voltage to be supplied to the actuator 40 of each of the recording heads HW1 and HW2 at the point P1 of the tracks Tr1 and Tr2 is not changed (step S15).

If it is determined in step S14 that the recording track widths W1 and W2 are not equal, this means that the recording track width W2 is smaller than the recording track width W1. Accordingly, the voltage −V2 for causing movement by −1 unit of the second unit (for example, for moving the recording head HW2 by −0.1 μm), for example, −1V, is added by to the control voltage for the actuator 40 of the recording head HW2 at the point P1 of the tracks Tr1 and Tr2, and the resultant is set as the control voltage for the actuator 40 of the recording head HW2 (step S16).

In this embodiment, the operations of the flow chart shown in FIG. 7 are sequentially executed in the manner as described above also with respect to the point P2, P3, . . . P11 of the tracks Tr1 and Tr2, thereby determining an updated control voltage to be supplied to the actuator 40 of each of the reproducing heads HR1 and HR2 at the point P1, P2, . . . P11 of the track Tr1 (Tr2).

Since the above-described processing is repeated in this embodiment, the recording track widths W1 and W2 at the points P1, P2, . . . P11 of the tracks Tr1 and Tr2 by the recording heads HW1 and HE2 can be made uniform at all times.

In this embodiment, during data recording (read-after-write), after executing the operations of the flow chart shown in FIG. 6 described above with respect to each of the points P1, P2, . . . P11 of the track Tr1 (Tr2), the operations of the flow chart shown in FIG. 7 described above are executed to each of the points P1, P2, . . . P11 of the track Tr1 (Tr2), and this processing is sequentially repeated.

According to this embodiment, the reproducing head HR1, HR2 scans the portion with the best error rate at each of a plurality of, for example, 11 points P1, P2, . . . . P11 of the track Tr1, Tr2, thereby making it possible to reproduce data in a satisfactory manner even in the case of a narrow track.

According to this embodiment, since wobbling is performed at a plurality of, for example, 11 points P1, P2, . . . . P11 of the track Tr1, Tr2 in determining an update of the control voltage for the actuator 40 of the reproducing head HR1, HR2, an error may occur at the point P1, P2, . . . . P11. However, there is no fear of an error occurring for the track as a whole, and data reproduction can be performed in a satisfactory manner.

Further, according to this embodiment, on the basis of the error rate profiles at a plurality of, for example, 11 points P1, P2, . . . . P11 of the track Tr1, Tr2, a control voltage is supplied to the actuator 40 of each of the recording heads HW1 and HW2 so that the recording track widths W1 and W2 by the recording heads HW1 and HW2 at these points P1, P2, . . . P11 becomes uniform. Therefore, the heights of the recording heads HW1 and HW2 are controlled in a satisfactory manner, and the recording track widths W1 and W2 can be made uniform at all times.

It is needless to mention that the present invention is not limited to the above-described embodiment but may adopt various other configurations without departing from the scope of the present invention.

What is claimed is:

1. A helical-scan-type magnetic tape recording and reproducing apparatus, comprising:
a helical-scan-type recording head configured to be movable, while being attached to a distal end of an actuator, in a track width direction due to displacement of the actuator itself so as to sequentially scan a magnetic tape;
a helical-scan-type reproducing head configured to be movable, while being attached to a distal end of an actuator, in the track width direction due to displacement of the actuator itself so as to sequentially scan a track on the magnetic tape recorded by the recording head;
error rate profile forming means for forming, by wobbling the reproducing head at each of a plurality of points on the track, error rate profiles at the plurality of points; and
reproducing-head moving means for moving the reproducing head at the plurality of points, by finding a point with the best error rate from each of the error rate profiles at the plurality of points from the error rate profile forming means.

2. A helical-scan-type magnetic tape recording and reproducing apparatus, comprising:
helical-scan-type first and second recording heads configured to be movable, while being attached to distal ends of respective actuators, in a track width direction due to displacement of the respective actuators themselves so as to sequentially scan a magnetic tape;
helical-scan-type first and second reproducing heads configured to be movable, while being attached to distal ends of respective actuators, in the track width direction due to displacement of the respective actuators themselves so as to sequentially scan first and second tracks on the magnetic tape recorded by the first and second recording heads;
error rate profile forming means for forming, by wobbling the first and second reproducing heads at each of a plurality of points on the tracks, error rate profiles at the plurality of points;
reproducing-head moving means for moving the reproducing heads at the plurality of points, by finding a point with the best error rate from each of the error rate profiles at the plurality of points from the error rate profile forming means;
track width calculating means for calculating widths of the tracks recorded by the first and second recording heads from the error rate profiles; and
track-width uniformizing means for supplying a control voltage to each of the actuators of the first and second recording heads so that track widths recorded by the first and second recording heads become uniform at the plurality of points.

3. The helical-scan-type magnetic tape recording and reproducing apparatus according to claim 1 or 2,
wherein the error rate profiles for the plurality of points are sequentially obtained for each point.

4. A helical-scan-type magnetic tape recording and reproducing method comprising the steps of:
forming first and second tracks by performing recording onto a magnetic tape by helical-scan-type first and second recording heads, the first and second recording heads being configured to be movable, while being attached to distal ends of respective actuators, in a track width direction due to displacement of the respective actuators themselves;
sequentially scanning by helical-scan-type first and second reproducing heads the first and second tracks on the magnetic tape recorded by the first and second recording heads, the first and second reproducing apparatus being configured to be movable, while being attached to distal ends of respective actuators, in the track width direction due to displacement of the respective actuators themselves;
forming, by wobbling the first and second reproducing heads at each of a plurality of points on the first and second tracks, error rate profiles at the plurality of points;
reproducing-head moving means for moving the reproducing heads at the plurality of points, by finding a point with the best error rate from each of the error rate profiles at the plurality of points;
calculating widths of the tracks recorded by the first and second recording heads from the error rate profiles; and
updating a control voltage to be supplied to each of the actuators of the first and second recording heads for each of the plurality of points so that track widths recorded by the first and second recording heads become uniform at the plurality of points.

5. The helical-scan-type magnetic tape recording and reproducing method according to claim 4,
wherein the steps are performed repeatedly.

6. A helical-scan-type magnetic tape recording and reproducing apparatus, comprising:
a helical-scan-type recording head configured to be movable, while being attached to a distal end of an actuator, in a track width direction due to displacement of the actuator itself so as to sequentially scan a magnetic tape;
a helical-scan-type reproducing head configured to be movable, while being attached to a distal end of an actuator, in the track width direction due to displacement of the actuator itself so as to sequentially scan a track on the magnetic tape recorded by the recording head;
an error rate profile forming mechanism forming, by wobbling the reproducing head at each of a plurality of points on the track, error rate profiles at the plurality of points; and
a reproducing-head moving mechanism moving the reproducing head at the plurality of points, by finding a point with the best error rate from each of the error rate profiles at the plurality of points from the error rate profile forming mechanism.

7. A helical-scan-type magnetic tape recording and reproducing apparatus, comprising:
helical-scan-type first and second recording heads configured to be movable, while being attached to distal ends of respective actuators, in a track width direction due to displacement of the respective actuators themselves so as to sequentially scan a magnetic tape;
helical-scan-type first and second reproducing heads configured to be movable, while being attached to distal ends of respective actuators, in the track width direction due to displacement of the respective actuators themselves so as to sequentially scan first and second tracks on the magnetic tape recorded by the first and second recording heads;
an error rate profile forming mechanism forming, by wobbling the first and second reproducing heads at each of a plurality of points on the tracks, error rate profiles at the plurality of points;
a reproducing-head moving mechanism moving the reproducing heads at the plurality of points, by finding a point with the best error rate from each of the error rate profiles at the plurality of points from the error rate profile forming mechanism;
a track width calculating mechanism calculating widths of the tracks recorded by the first and second recording heads from the error rate profiles; and
a track-width uniformizing mechanism supplying a control voltage to each of the actuators of the first and second recording heads so that track widths recorded by the first and second recording heads become uniform at the plurality of points.
